(19) United States
(12) Patent Application Publication
(10) Pub. No.: US 2007/0277351 A1
(43) Pub. Date: Dec. 6, 2007

(54) ADJUSTABLE HINGE FOR A DISPLAY

(75) Inventor: Chin-Jui HUNG, Taichung Hsien (TW)

Correspondence Address: PATENTTM.US, P. O. BOX 82788, PORTLAND, OR, 97282-0788, US

(73) Assignee: MODERNSOLID INDUSTRIAL CO., LTD., Taichung Hsien (TW)

(21) Appl. No.: 11/530,629

(22) Filed: Sep. 11, 2006

(30) Foreign Application Priority Data
Jun. 6, 2006 (TW) 095209825

(51) Int. Cl. E05D 3/06

(52) U.S. Cl. 16/366

(57) ABSTRACT

A hinge includes a base and two supporting assemblies slidably connected to the base. Each supporting assembly has four arms pivotally sandwiched between a connection rod which is slidable relative to the base and an attachment rod which is adapted to engage with a display. Friction disks are provided to opposed sides of each of the four arms so that when the attachment rod is pivoted relative to the connection rod, the friction disks are able to provide necessary friction force to support the display securely connected to the attachment rod.

### BACKGROUND OF THE INVENTION

1. Field of the Invention

The present invention relates to a hinge, and more particularly to a hinge which is able to provide an adjustable feature to a display to provide more convenient observation alternatives.

2. Description of Related Art

As well known in the art, a hinge is provided between two objects so as to provide a pivotal relationship between the two objects. Examples can be seen everywhere in our daily lives. A common example is the display of a computer, wherein the display pivots about a central axis so that various observation angles are provided for operators at different positions. However, the conventional hinge depends on one single arm to provide the necessary pivotal movement between two objects, which is not strong enough to support pivotal movement of large object or the friction from the single arm is not large enough to support the weight of the object so that often it is seen that over the time the hinge can no longer provide the necessary pivotal movement as well as the friction to the object.

Due to the drawback, another hinge having two arms is provided to the market. The hinge having two arms does provide a strong support to the object attached to the hinge. However, when it comes to the adjustment of the hinge, the user has to prepare auxiliary tools so as to perform the adjustment smoothly. That is, without the auxiliary tool, the user will have difficulty adjusting the angle of the hinge.

To overcome the shortcomings, the present invention tends to provide an improved hinge to mitigate the aforementioned problems.

### SUMMARY OF THE INVENTION

The primary objective of the present invention is to provide an improved hinge having four arms to provide the pivotal movement of an object as well as the friction to support the weight of the object.

Another objective of the present invention is to provide a safety device formed on a side of one of the four arms to abut a bottom face of a base so as to prevent escape of the arms from engagement with the base.

Still, another objective of the present invention is that due to four arms being pivotally connected to the supporting assemblies, when the user is trying to adjust the angle of the hinge, it is quite easy for the user to freely adjust the angle of the hinge.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the hinge of the present invention;

FIG. 2 is an exploded perspective view of one supporting assembly of the hinge of the present invention;

FIGS. 3 and 4 are side views showing that the display attached to the hinge of the present invention is pivoted relative to the base of the hinge of the present invention; and

FIG. 5 is a side plan view showing that the safety device is effected to prevent accidental detachment of the supporting assembly from the base.

### DETAILED DESCRIPTION OF THE PREFERRED EMBODIMENT

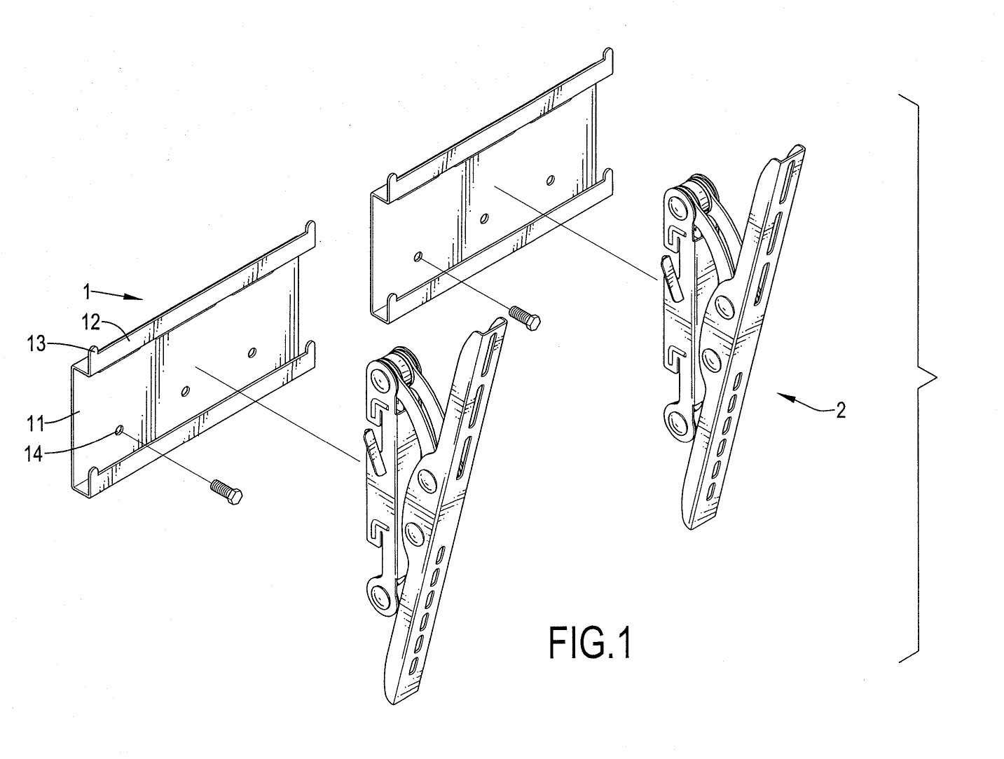

With reference to FIG. 1, the hinge in accordance with the present invention includes a base (1) (two bases (1) may be provided) and two supporting assemblies (2).

The base (1) includes a substantially U shaped substrate (11) and two upright skirts (12) each extending from two opposed free sides of the substrate (11) and provided with a stop (13) formed on two opposed ends of each of the skirts (12). Assembly holes (14) are defined through the substrate (11).

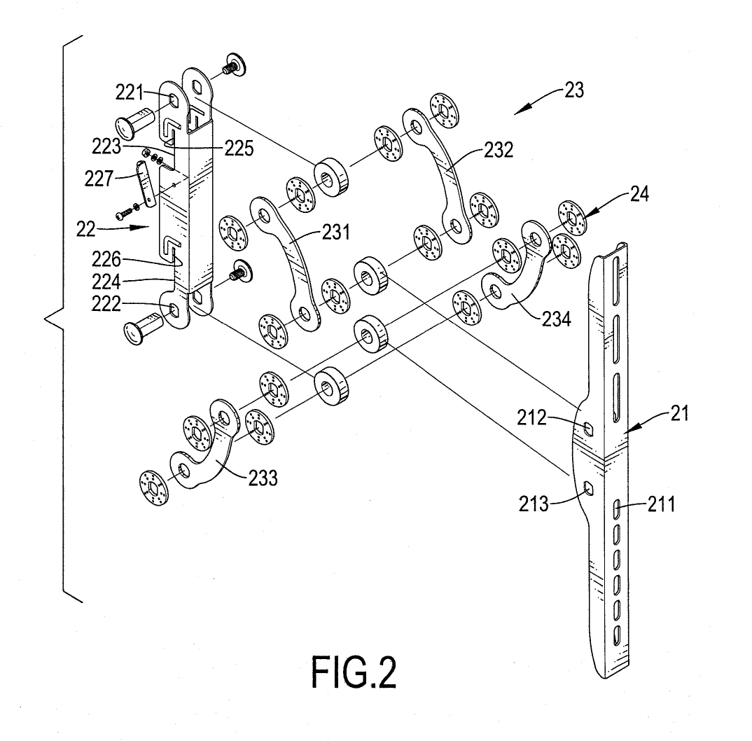

With reference to FIG. 2, each of the supporting assembly (2) includes an attachment rod (21), a connection rod (22), four arms (23) sandwiched between the attachment rod (21) and the connection rod (22) and friction disks (24).

The attachment rod (21) has multiple attachment holes (211) for engagement with a display (not shown) and a pair of first through holes, an upper through hole (212) and a lower through hole (213), defined through a side face of the attachment rod (21). The connection rod (22) includes a top connection hole (221) defined in a proximal end of the connection rod (22), a bottom connection hole (222), a top neck (223) formed on a top portion of the connection rod (22), a bottom neck (224) formed on a bottom portion of the connection rod (22), a top slit (225) defined in a side face of the top neck (223), a bottom slit (226) defined in a side face of the bottom neck (224) and a safety pin (227) secured to yet movable relative to a side face of the connection rod (22).

A first arm (231), a second aim (232), a third arm (233) and a fourth arm (234) respectively have a top hole and a bottom hole defined in a proximal end and a distal end of each of the first arm (231), the second aim (232), the third arm (233) and the forth arm (234) to respectively correspond to the top connection hole (221) of the connection rod (22), the upper through hole (212) of the attachment rod (21) and the lower through hole (213) of the attachment rod (21) and the bottom connection hole (222) of the connection rod (22). The friction disks (24) are provided on opposed sides of the top hole and the bottom hole of each of the first aim (231), the second arm (232), the third arm (233) and the fourth arm (234) so that when the first arm (231), the second aim (232), the third arm (233) and the forth aim (234) are respectively connected and secured to the top connection hole (221) of the connection rod (22), the upper through hole (212) of the attachment rod (21) and the lower through hole (213) of the attachment rod (21) and the bottom connection hole (222) of the connection rod (22), the friction disks (24) are able to provide the necessary friction to support weight of an object.

It is noted that after the supporting assembly (2) is assembled and when the supporting assembly (2) is to be connected to the base (1), the skirt (12) formed on top of the substrate (11) is received in the top slit (225) and the skirt (12) formed on the bottom of the substrate (11) is received in the bottom slit (226) of the base (1). Thereafter, the assembly of the hinge of the present invention is completed.

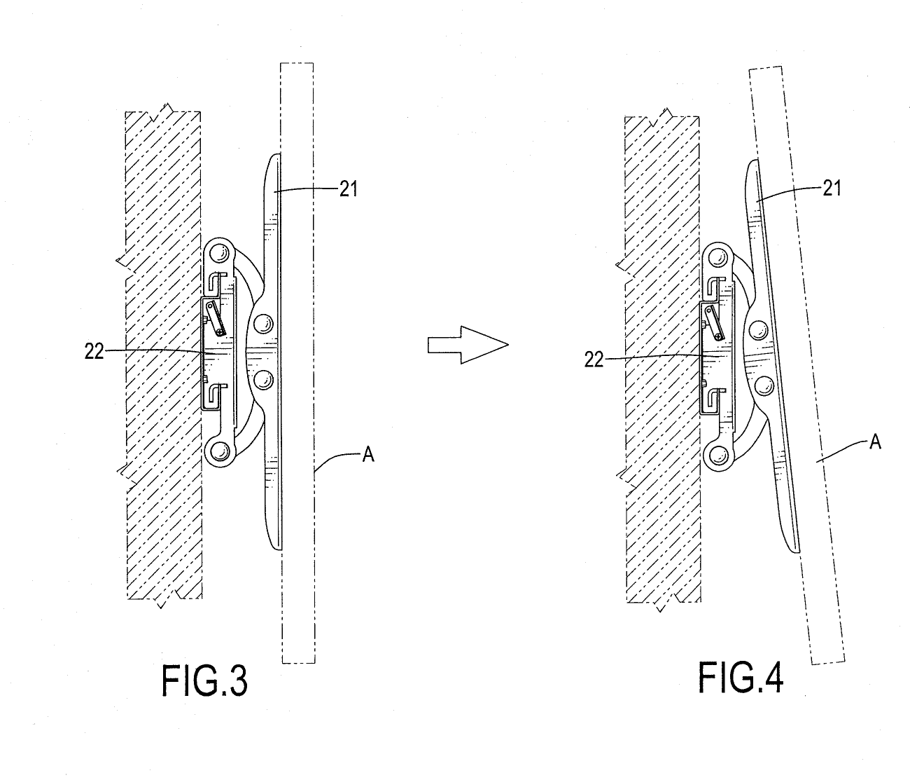

With reference to FIGS. 3 and 4, it is noted that a display (A) is securely connected to the attachment rod (21) via the attachment holes (211). Due to the arrangement of the attachment holes (211), the operator is able to adjust the position of the display (A) relative to the attachment rod (21). Then due to the friction disks (24), as shown in FIG. 2, as well as the arms (23), the attachment rod (21) together with the display (A) is able to pivot relative to the connection rod (22) which is firmly connected to a wall.

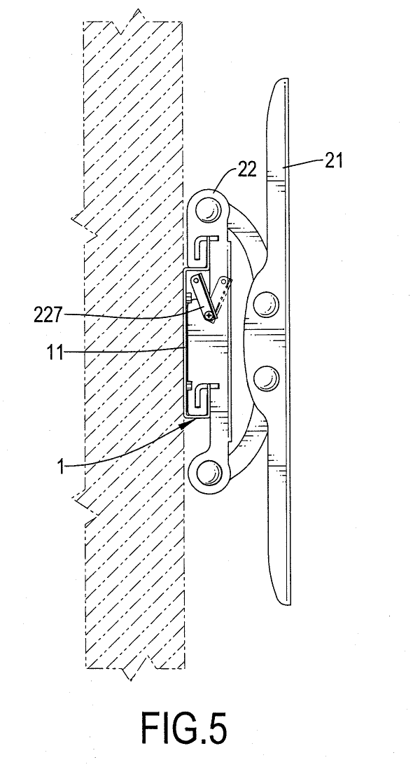

With reference to FIGS. 2 and 5, it is noted that a safety device (227) is secured yet pivotable relative to a side face of the connection rod (22). Therefore, before the supporting assembly (2) is connected to the base (1), the safety pin (227) is pivoted toward the attachment rod (21) to allow the skirts (12) to be received in the top slit (225) and the bottom slit (226) respectively. After the supporting assembly (2) is securely connected to the base (1), the safety pin (227) is pivoted away from the attachment rod (21) to face an inner wall of the substrate (11) such that once the supporting assembly (2) is assembled with the base (1) and the safety pin (227) is pivoted to face and abut against the inner wall of the substrate (11), accidental detachment between the supporting assembly (2) and the base (1) is avoided.

In addition, as described earlier that when there are two bases (1) respectively provided to the two supporting assemblies (2), the operator is able to adjust the position of the display (A) within a much greater distance than in a situation where there is only one base (1). Due to the four aims provision and the pivotal connection to the supporting assemblies, it is easy for the user to freely adjust angle of the hinge.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A hinge comprising:
at least one base adapted to be securely connected to a wall and having a U-shaped substrate and two skirts respectively extending upright on two opposed sides of the substrate;
at least one supporting assembly for engagement with a display and slidably connected to the at least one base, the at least one supporting assembly having an attachment rod, a connection rod, four arms sandwiched between the attachment rod and the connection rod and friction disks, wherein
the attachment rod has multiple attachment holes for engagement with the display, an upper through hole and a lower through hole respectively defined through a side face of the attachment rod,
the connection rod includes a top connection hole defined in a proximal end thereof, a bottom connection hole defined in a distal end thereof, a top neck formed on a top portion of the connection rod, a bottom neck formed on a bottom portion of the connection rod, a top slit defined in a side face of the top neck to slidably receive therein a top skirt of the two skirts of the at least one base and a bottom slit defined in a side face of the bottom neck to slidably receive therein a bottom skirt of the two skirts of the at least one base,
the arm has a first arm, a second arm, a third arm and a fourth arm respectively have a top hole and a bottom hole defined in a proximal end and a distal end of each of the first arm, the second arm, the third arm and the forth arm to respectively correspond to the top connection hole of the connection rod, the upper through hole of the attachment rod and the lower through hole of the attachment rod and the bottom connection hole of the connection rod,
the friction disks are provided on opposed sides of the top hole and the bottom hole of each of the first aim, the second arm, the third arm and the fourth aim so that when the first arm, the second aim, the third arm and the forth arm are respectively connected and secured to the top connection hole of the connection rod, the upper through hole of the attachment rod and the lower through hole of the attachment rod and the bottom connection hole of the connection rod, the friction disks are able to provide necessary friction to support weight of the display.

2. The hinge as claimed in claim 1, wherein a safety pin is secured to yet movable relative to a side face of the connection rod to be able to face and abut against an inner face of the substrate to prevent accidental separation between the at least one supporting assembly and the at least one base.

3. The hinge as claimed in claim 2, wherein each of the two skirts has two stops respectively formed on two opposed ends of each of the two skirts.

4. The hinge as claimed in claim 3, wherein there are two bases and two supporting assemblies each corresponding to one of the two bases.
